(19) United States
(12) Patent Application Publication
(10) Pub. No.: US 2021/0174820 A1
(43) Pub. Date: Jun. 10, 2021

(54) SIGNAL PROCESSING APPARATUS, VOICE SPEECH COMMUNICATION TERMINAL, SIGNAL PROCESSING METHOD, AND SIGNAL PROCESSING PROGRAM

(71) Applicants: NEC Corporation, Minato-ku, Tokyo (JP); NEC p|atforms, Ltd., Kawasaki-shi, Kanagawa (JP)

(72) Inventors: Akihiko SUGIYAMA, Tokyo (JP); Ryoji MIYAHARA, Kanagawa (JP)

(73) Assignees: NEC Corporation, Minato-ku, Tokyo (JP); NEC p|atforms, Ltd., Kawasaki-shi, Kanagawa (JP)

(21) Appl. No.: 17/270,292

(22) PCT Filed: Aug. 24, 2018
(86) PCT No.: PCT/JP2018/031455

§ 371 Date: Feb. 22, 2021

(51) Int. Cl. G10L 21/034; G10L 21/0216

(52) U.S. Cl. CPC G10L 21/034; G10L 2021/02163; G10L 21/0216

(57) ABSTRACT

This invention provides a signal processing apparatus for receiving a mixed signal including at least one target signal and outputting a desired composite signal. The signal processing apparatus includes a storage unit that stores an acoustic signal, and a signal processor that receives a mixed signal including at least one target signal, and composites the acoustic signal stored in a storage unit with the at least one target signal.

### TECHNICAL FIELD

The present invention relates to a signal processing apparatus, a voice speech communication terminal, a signal processing method, and a signal processing program.

### BACKGROUND ART

In the above technical field, patent literature 1 discloses a technique of inputting a voice and noise, selecting another noise of the same type as the analyzed noise from a database prepared in advance, and adding the noise to the voice.

### CITATION LIST

### Patent Literature

Patent literature 1: U.S. Pat. No. 8,798,992B2
Patent literature 2: Japanese Patent Laid-Open No. 2002-204175
Patent literature 3: WO 2007/026691
Patent literature 4: Japanese Patent Laid-Open No. 2007-68125
Patent literature 5: WO 2015/049921
Patent literature 6: Japanese Patent Laid-Open No. 9-18291
Patent literature 7: WO 2005/024787

### Non-Patent Literature

Non-patent literature 1: IEEE TRANSACTIONS ON ACOUSTIC, SPEECH, AND SIGNAL PROCESSING, Vol. 27, No. 2, pp. 113-120, April 1979
Non-patent literature 2: IEEE TRANSACTIONS ON ACOUSTIC, SPEECH, AND SIGNAL PROCESSING, Vol. 32, No. 6, pp. 1109-1121, December 1984
Non-patent literature 3: IEEE TRANSACTIONS ON ANTENNAS, AND PROPAGATION, Vol. 30, No. 1, pp. 27-34, January 1982
Non-patent literature 4: HANDBOOK OF SPEECH PROCESSING, SPRINGER, BERLIN HEIDELBERG NEW YORK, 2008.
Non-patent literature 5: IEEE PROCEEDINGS OF INTERNATIONAL CONFERENCE ON ACOUSTICS, SPEECH, AND SIGNAL PROCESSING, pp. 524-528, April 2015
Non-patent literature 6: PROCEEDINGS OF IEEE, Vol. 63, No. 12, pp. 1692-1716, December 1975

### SUMMARY OF THE INVENTION

### Technical Problem

In the technique described in the above literature, however, the voice and noise are assumed to be input in a separated state. Hence, the technique cannot be applied if a voice and noise are obtained only in a mixed state.

The present invention enables to provide a technique of solving the above-described problem.

### Solution to Problem

One example aspect of the present invention provides a signal processing apparatus comprising:

a storage unit that stores an acoustic signal; and

a signal processor that receives a mixed signal including at least one target signal, and composites the acoustic signal stored in the storage unit with the target signal.

Another example aspect of the present invention provides a voice speech communication terminal incorporating the above-described signal processing apparatus, comprising

a microphone that inputs a mixed signal,

wherein a signal processor composites a user voice signal as a target signal included in the input mixed signal with an acoustic signal prepared in advance, and

the voice speech communication terminal further comprises a transmitter that transmits a composited composite signal.

Still other example aspect of the present invention provides a voice speech communication terminal incorporating the above-described signal processing apparatus, comprising

a receiver that receives a mixed signal from a calling-side voice speech communication terminal,

wherein a signal processor composites a user voice signal as a target signal included in the received mixed signal with an acoustic signal prepared in advance, and

the voice speech communication terminal further comprises a voice output unit that outputs a composited composite signal as a voice.

Still other example aspect of the present invention provides a signal processing method comprising:

receiving a mixed signal including at least one target signal; and

compositing an acoustic signal stored in advance with the target signal.

Still other example aspect of the present invention provides a signal processing program for causing a computer to execute a method, comprising:

receiving a mixed signal including at least one target signal; and

compositing an acoustic signal stored in advance with the target signal.

### Advantageous Effects of Invention

According to the present invention, it is possible to receive a mixed signal including at least one target signal and output a desired composite signal.

### BRIEF DESCRIPTION OF DRAWINGS

FIG. 1 is a block diagram showing the arrangement of a signal processing apparatus according to the first example embodiment of the present invention;

FIG. 2 is a block diagram showing the arrangement of a signal processing apparatus according to the second example embodiment of the present invention;

FIG. 3 is a block diagram showing the arrangement of an extractor according to the second example embodiment of the present invention;

FIG. 4 is a block diagram showing the arrangement of a voice detector according to the second example embodiment of the present invention;

FIG. 5 is a block diagram showing the arrangement of a consonant detector according to the second example embodiment of the present invention;

FIG. 6 is a block diagram showing the arrangement of a vowel detector according to the second example embodiment of the present invention;

FIG. 7 is a block diagram showing the arrangement of an impact sound detector according to the second example embodiment of the present invention;

FIG. 8 is a block diagram showing the arrangement of an amplitude corrector according to the second example embodiment of the present invention;

FIG. 9 is a block diagram showing the arrangement of a phase corrector according to the second example embodiment of the present invention;

FIG. 10 is a block diagram showing the arrangement of an extractor according to the third example embodiment of the present invention;

FIG. 11 is a block diagram showing the arrangement of a signal processor according to the fourth example embodiment of the present invention;

FIG. 12 is a block diagram showing the arrangement of a separator according to the fourth example embodiment of the present invention;

FIG. 13 is a block diagram showing the arrangement of a separator according to the fifth example embodiment of the present invention;

FIG. 14 is a block diagram showing the arrangement of a separator according to the sixth example embodiment of the present invention;

FIG. 15 is a block diagram showing the arrangement of a signal processing apparatus according to the seventh example embodiment of the present invention;

FIG. 16 is a block diagram showing the arrangement of a signal processing apparatus according to the eighth example embodiment of the present invention;

FIG. 17 is a block diagram showing the arrangement of a signal processing apparatus according to the ninth example embodiment of the present invention;

FIG. 18 is a block diagram showing an arrangement of a signal processor according to the ninth example embodiment of the present invention;

FIG. 19 is a block diagram showing another arrangement of the signal processor according to the ninth example embodiment of the present invention;

FIG. 20 is a block diagram showing the arrangement of a signal processing apparatus according to the 10th example embodiment of the present invention;

FIG. 21 is a block diagram showing the arrangement of a signal processor according to the 10th example embodiment of the present invention;

FIG. 22 is a block diagram showing the arrangement of a signal processing apparatus according to the 11th example embodiment of the present invention;

FIG. 23 is a flowchart showing the procedure of processing of the signal processing apparatus according to the 11th example embodiment of the present invention;

FIG. 24 is a flowchart showing the procedure of processing of the signal processing apparatus according to the 11th example embodiment of the present invention;

FIG. 25 is a block diagram showing the arrangement of a voice speech communication terminal according to the 12th example embodiment of the present invention;

FIG. 26 is a view showing the arrangement of an acoustic signal selection database according to the 12th example embodiment of the present invention; and

FIG. 27 is a block diagram showing the arrangement of a voice speech communication terminal according to the 13th example embodiment of the present invention.

### DESCRIPTION OF EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise. Note that “voice signal” in the following description is a direct electrical change that occurs according to a voice or another sound and means a signal used to transmit a voice or another sound, and is not limited to a voice. In some example embodiments, an apparatus in which the number of mixed signals to be input is four will be described. However, this is merely an example, and the same description applies to an arbitrary signal count of two or more. Additionally, in the description even if the amplitude of a signal used in a portion is replaced with the power of the signal, and the power of a signal used in a portion is replaced with the amplitude of the signal, the same description applies. This is because a power is obtained as the square of an amplitude, and an amplitude is obtained as the square root of a power.

### First Example Embodiment

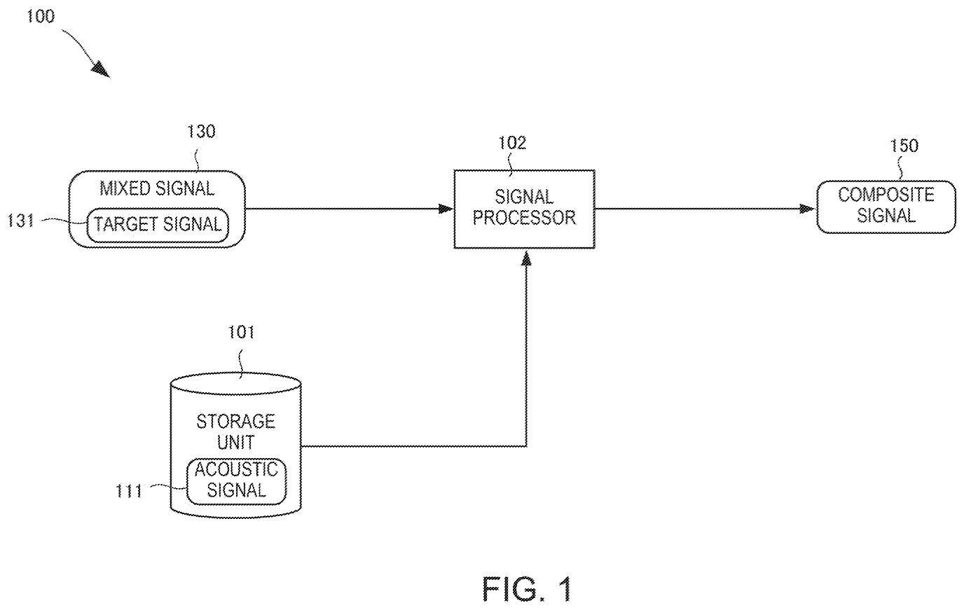

A signal processing apparatus 100 according to the first example embodiment of the present invention will be described with reference to FIG. 1. As shown in FIG. 1, the signal processing apparatus 100 includes a storage unit 101 and a signal processor 102.

The storage unit 101 stores an acoustic signal 111.

The signal processor 102 receives a mixed signal 130 including at least one target signal 131, and composites the acoustic signal 111 stored in the storage unit 101 with the target signal 131.

According to this example embodiment, it is possible to input a mixed signal in which a voice and noise are mixed and output a desired composite signal 150.

### Second Example Embodiment

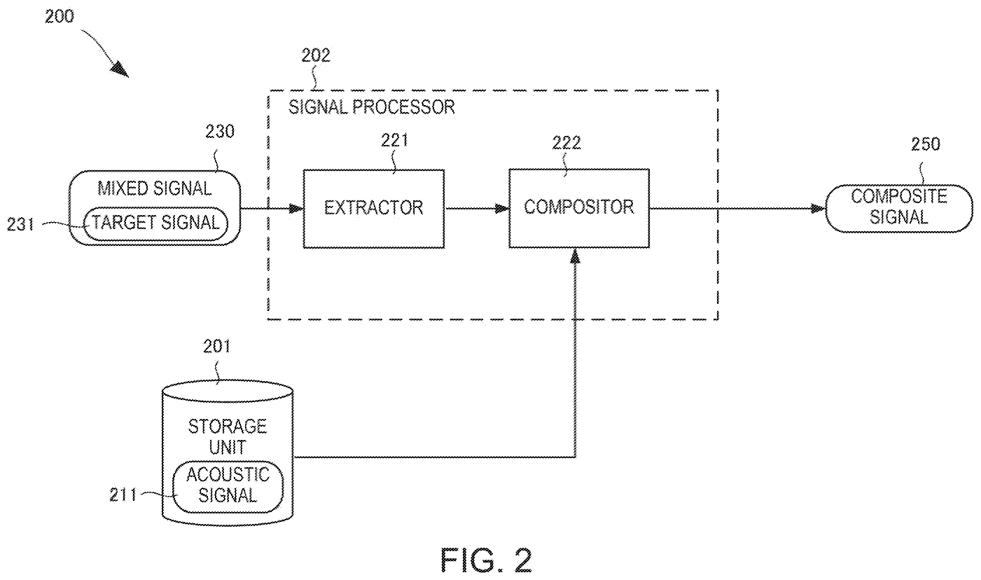

A signal processing apparatus 200 according to the second example embodiment of the present invention will be described next with reference to FIG. 2. FIG. 2 is a block diagram for explaining the arrangement of the signal processing apparatus 200 according to this example embodiment. The signal processing apparatus 200 is an apparatus that inputs a mixed signal in which a target signal (for example, a voice) and a background signal (for example, an environmental sound) are mixed from a sensor such as a microphone or an external terminal, and replaces the background signal with another acoustic signal to generate a replaced acoustic signal.

The signal processing apparatus 200 according to this example embodiment includes a storage unit 201 and a signal processor 202.

The storage unit 201 stores an acoustic signal 211. The storage unit 201 stores an acoustic signal to be composited with a target signal in advance before the signal processing apparatus 200 starts an operation.

The signal processor 202 includes an extractor 221 that receives a mixed signal 230 and extracts at least one target signal 231, and a compositor 222 that composites the acoustic signal 211 and the target signal 231.

Using the acoustic signal 211 supplied from the storage unit 201, the signal processor 202 obtains a composite signal 250 in which the target signal and an acoustic signal (replaced background signal) different from the background signal are mixed.

The extractor 221 receives the mixed signal including the target signal and the background signal, extracts the target signal, and outputs it.

The compositor 222 receives the target signal 231 and the acoustic signal 211 stored in the storage unit 201, composites the target signal 231 with the acoustic signal 211, and outputs these as a composite signal 250. The compositor 222 may simply add the target signal and the acoustic signal, or may add them by applying a different addition ratio at a different frequency. Alternatively, psycho-acoustic analysis may be performed, and the result may be used when adding.

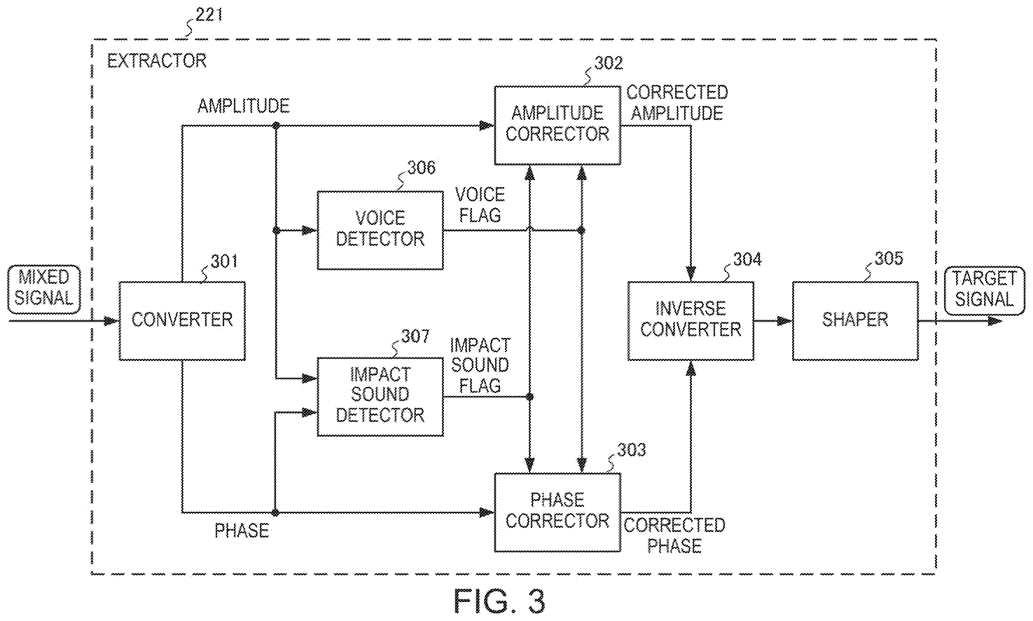

FIG. 3 is a block diagram showing an example of the arrangement of the extractor 221. As shown in FIG. 3, the extractor 221 includes a converter 301, an amplitude corrector 302, a phase corrector 303, an inverse converter 304, a shaper 305, a voice detector 306, and an impact sound detector 307.

The converter 301 receives a mixed signal, puts a plurality of signal samples into blocks, and decomposes them into amplitudes and phases at a plurality of frequency components by applying frequency conversion. As the frequency conversion, various transformations such as Fourier transformation, cosine transformation, sine transformation, wavelet transformation, and Hadamard transform can be used. Additionally, before the conversion, multiplication of a window function is widely performed on a block basis. Also, overlap processing of making a part of a block overlap a part of an adjacent block is widely applied. It is also possible to integrate the plurality of obtained signal samples into a plurality of groups (sub-bands) and commonly use a value representing each group for frequency components in each group. It is also possible to handle each sub-band as a new frequency point and decrease the number of frequency points. Furthermore, instead of performing frequency conversion based on block processing, processing on a sample basis can be performed using an analysis filter bank to obtain data corresponding to a plurality of frequency points. At this time, a uniform filter bank in which the frequency points are arranged at equal intervals on the frequency axis or a nonuniform filter bank in which the frequency points are arranged at inequal intervals can be used. In the nonuniform filter bank, setting is done such that the frequency interval is narrow in the important frequency band of an input signal. For a voice, setting is done such that the frequency interval is narrow in a low-frequency region.

The voice detector 306 receives amplitudes at the plurality of frequencies from the converter 301, detects the existence of a voice, and outputs it as a voice flag. The impact sound detector 307 receives amplitudes and phases at the plurality of frequencies from the converter 301, detects the existence of an impact sound, and outputs it as an impact sound flag. The amplitude corrector 302 receives the amplitudes at the plurality of frequencies from the converter 301, the voice flag from the voice detector 306, and the impact sound flag from the impact sound detector 307, corrects the amplitudes at the plurality of frequencies, and outputs a corrected amplitude. The phase corrector 303 receives the phases at the plurality of frequencies from the converter 301, the voice flag from the voice detector 306, and the impact sound flag from the impact sound detector 307, corrects the phases at the plurality of frequencies, and outputs a corrected phase.

The inverse converter 304 receives the corrected amplitude from the amplitude corrector 302 and the corrected phase from the phase corrector 303, obtains a time domain signal by applying inverse frequency conversion, and outputs it. The inverse converter 304 performs inverse conversion of the conversion applied by the converter 301. For example, if the converter 301 executes Fourier transformation, the inverse converter 304 executes inverse Fourier transformation. As in the converter 301, a window function or overlap processing is also widely applied. When the converter 301 integrates the plurality of signal samples into the plurality of groups (sub-bands), a value representing each sub-band is copied as the value of all frequency points in each sub-band, and after that, inverse conversion is executed.

The shaper 305 receives the time domain signal from the inverse converter 304, executes shaping processing, and outputs the shaping result as the target signal. Shaping processing includes smoothing and prediction of a signal. When smoothing is performed, the shaping result changes more smoothly with time as compared to the plurality of signal samples received from the inverse converter 304. When linear prediction is performed, the shaper obtains the shaping result as the linear combination of the plurality of signal samples received from the inverse converter 304. A coefficient representing the linear combination can be obtained by the Levinson-Durbin algorithm using the plurality of signal samples received from the inverse converter 304.

The shaper 305 can also obtain the coefficient representing the linear combination using a gradient method or the like such that the expectation value of the square error of the difference between the latest sample, that is, a sample that is temporally the latest in the plurality of signal samples received from the inverse converter 304 and a result (linear combination of a past sample using a prediction coefficient) of predicting the latest sample using a past sample relative to the latest sample is minimized. Since a missing harmonic component is compensated, the linear combination result changes more smoothly with time as compared to the plurality of signal samples received from the inverse converter 304. The shaper 305 may perform nonlinear prediction based on a nonlinear filter such as a Volterra filter.

Note that in FIG. 3, the converter 301 and the inverse converter 304 are not essential. Processing in the voice detector 306 may be executed in the time domain directly or as equivalent processing. Although processing in the impact sound detector 307 cannot be executed directly in the time domain, impact sound detection can be executed by detecting an abrupt increase and an abrupt decrease in signal power.

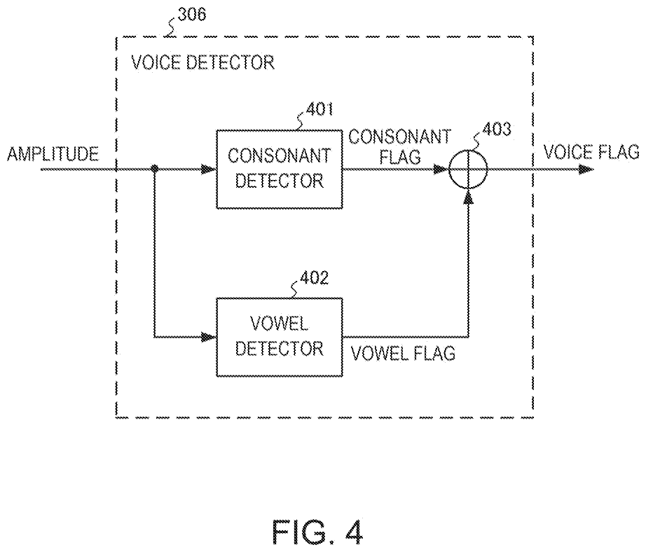

FIG. 4 is a block diagram showing an example of the arrangement of the voice detector 306. As shown in FIG. 4, the voice detector 306 includes a consonant detector 401, a vowel detector 402, and an OR calculator 403.

The consonant detector 401 receives the amplitudes at the plurality of frequencies, detects a consonant on a frequency basis, and outputs, as a consonant flag, 1 when a consonant is detected, and 0 when a consonant is not detected. The vowel detector 402 receives the amplitudes at the plurality of frequencies, detects a vowel on a frequency basis, and outputs, as a vowel flag, 1 when a vowel is detected, and 0 when a vowel is not detected. The OR calculator 403 receives the consonant flag from the consonant detector 401 and the vowel flag from the vowel detector 402 obtains the OR of the flags, and outputs a voice flag. That is, the voice flag is 1 when one of the consonant flag and the vowel flag is 1, or 0 when both the consonant flag and the vowel flag are 0. When one of a consonant and a vowel exists, it is determined that a voice exists.

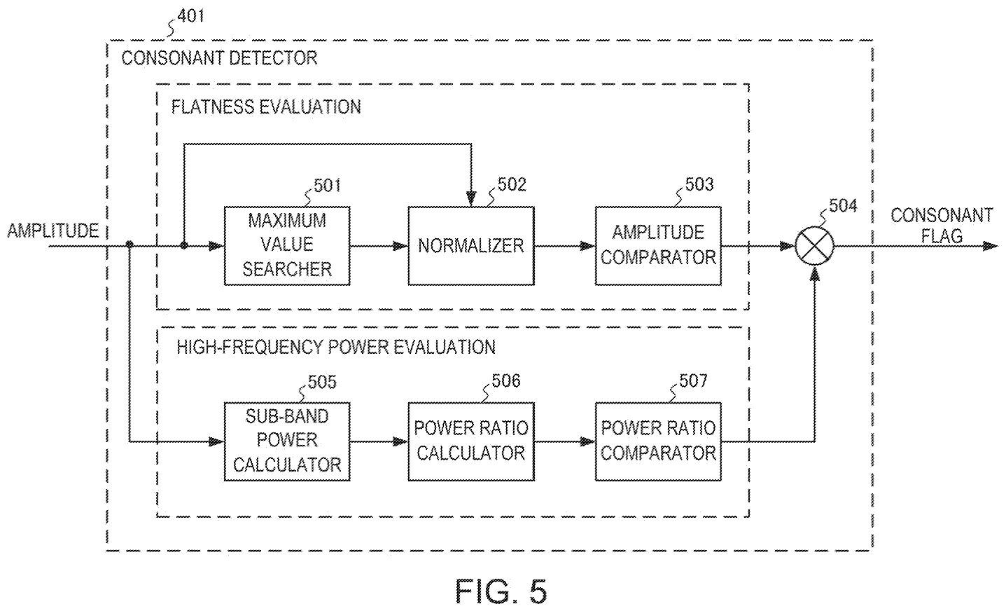

FIG. 5 is a block diagram showing an example of the arrangement of the consonant detector 401 included in the voice detector 306 shown in FIG. 4. As shown in FIG. 5, the consonant detector 401 includes a maximum value searcher 501, a normalizer 502, an amplitude comparator 503, a sub-band power calculator 505, a power ratio calculator 506, a power ratio comparator 507, and an AND calculator 504.

The maximum value searcher 501, the normalizer 502, and the amplitude comparator 503 form a flatness evaluator that detects that the flatness of an amplitude spectrum is high throughout all bands. The sub-band power calculator 505, the power ratio calculator 506, and the power ratio comparator 507 form a high-frequency power evaluator that detects that a power in a high-frequency range is large. The AND calculator 504 outputs, as a consonant flag, 1 when two conditions that the amplitude spectrum flatness is high, and the high-frequency power is large are satisfied, or 0 when the conditions are not satisfied. The consonant detector 401 may include only one of the flatness evaluator and the high-frequency power evaluator.

The maximum value searcher 501 receives the amplitudes at the plurality of frequencies and obtains the maximum value. The normalizer 502 obtains the sum of the amplitudes at the plurality of frequencies, and normalizes it by the maximum value obtained by the maximum value searcher 501, thereby obtaining a normalized total amplitude. The amplitude comparator 503 receives the normalized total amplitude from the normalizer 502, compares it with a predetermined threshold, and outputs 1 if the normalized total amplitude is larger than the threshold or 0 otherwise. If the flatness of the amplitude spectrum is high, the maximum value of the amplitude almost equals the other amplitudes is not remarkably large. Hence, the normalized total amplitude relatively has a large value. For this reason, if the normalized total amplitude exceeds the threshold, it is judged that the flatness of the amplitude spectrum is high, and the output of the amplitude comparator 503 is set to 1. Conversely, if the flatness of the amplitude spectrum is low, the variance of amplitude values is large, and the possibility that the maximum value is much larger than the other amplitudes is high. Hence, the normalized total amplitude relatively has a small value. In this case, the normalized total amplitude does not have a value larger than the threshold, and the output of the amplitude comparator 503 is set to 0. By the above-described operation, the maximum value searcher 501, the normalizer 502, and the amplitude comparator 503 can detect that the flatness of the amplitude spectrum is high throughout all bands.

The sub-band power calculator 505 receives the amplitudes at the plurality of frequencies, and calculates the intra-sub-band total power for each of a plurality of sub-bands that form the subsets of all frequency points. The sub-bands may equally divide or unequally divide all the bands.

The power ratio calculator 506 receives the plurality of sub-band powers from the sub-band power calculator 505, and calculates a power ratio by dividing the power of a high-frequency sub-band by the power of a low-frequency sub-band. If the number of sub-bands is two, the power ratio calculation method is uniquely determined. If the number of sub-bands exceeds two, the high-frequency sub-band and the low-frequency sub-band are arbitrarily selected. Arbitrary sub-bands are selected, and the total power of sub-bands in which the frequency is always high is divided by the total power of sub-bands in which the frequency is low, thereby calculating the power ratio.

The power ratio comparator 507 receives the power ratio from the power ratio calculator 506, compares it with a predetermined threshold, and outputs 1 if the power ratio is larger than the threshold or 0 otherwise. If a high-frequency power is larger than a low-frequency power, a voice is a consonant at a high probability. Conversely, it is known that a low-frequency power is larger than a high-frequency power in a vowel. Hence, the powers of a high frequency and a low frequency are calculated, and the ratio is compared with a threshold, thereby determining whether a voice is a consonant or not. By the above-described operation, the sub-band power calculator 505, the power ratio calculator 506, and the power ratio comparator 507 can detect that the power of a high frequency is large.

The AND calculator 504 calculates the AND of flatness evaluation and high-frequency power evaluation, thereby determining a voice with a large high-frequency power as a consonant.

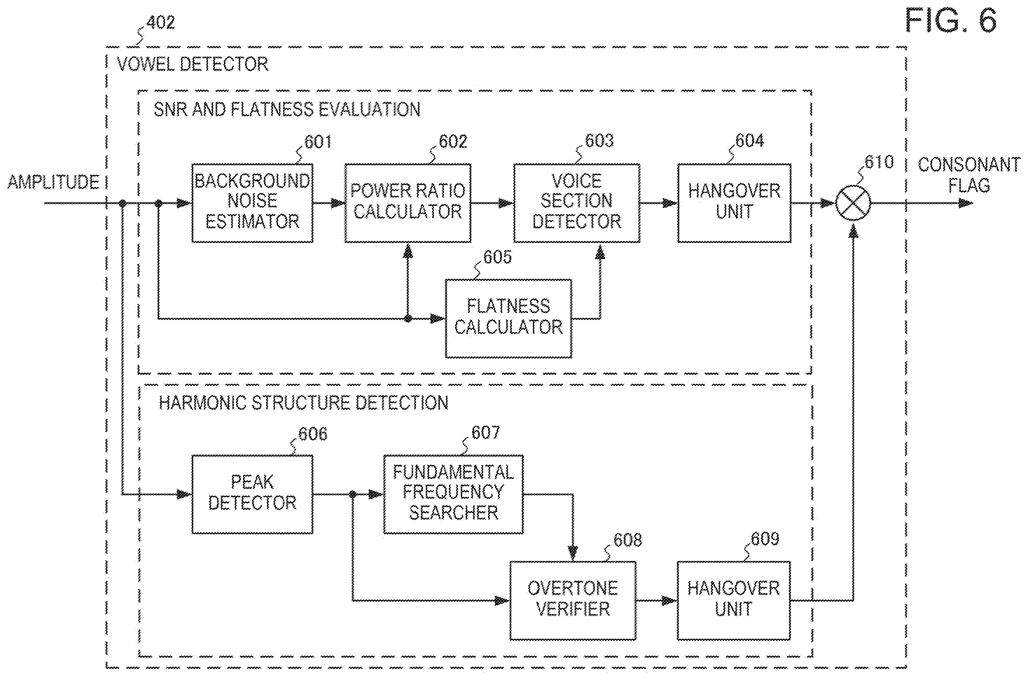

FIG. 6 is a block diagram showing an example embodiment of the arrangement of the vowel detector 402 included in the voice detector 306 shown in FIG. 4. As shown in FIG. 6, the vowel detector 402 has an arrangement including a background noise estimator 601, a power ratio calculator 602, a voice section detector 603, a hangover unit 604, a flatness calculator 605, a peak detector 606, a fundamental frequency searcher 607, an overtone verifier 608, a hangover unit 609, and an AND calculator 610.

The background noise estimator 601, the power ratio calculator 602, the voice section detector 603, the hangover unit 604, and the flatness calculator 605 form an SNR and flatness evaluator that detects that the SNR (Signal to Noise Ratio) is high, and the amplitude spectrum flatness is high. The peak detector 606, the fundamental frequency searcher 607, the overtone verifier 608, and the hangover unit 609 form a harmonic structure detector that detects the existence of a harmonic structure. The AND calculator 610 outputs, as a vowel flag, 1 when three conditions that the SNR is high, the amplitude spectrum flatness is high, and a harmonic structure exists are satisfied, or 0 when the conditions are not satisfied. The vowel detector may be formed by one of the SNR and flatness evaluator and the harmonic structure detector.

The background noise estimator 601 receives the amplitudes at the plurality of frequencies, and estimates background noise on a frequency basis. Background noise may include all signal components other than the target signal. As the noise estimation method, a minimum statistics method, weighted noise estimation, and the like are disclosed in non-patent literature 1 and non-patent literature 2. However, a method other than these can also be used. The power ratio calculator 602 receives the amplitudes at the plurality of frequencies and background noise estimation values at the plurality of frequencies, which are calculated by the background noise estimator 601, and calculates a plurality of power ratios at each frequency. When the estimated noise is set to the denominator, the power ratio approximately represents the SNR.

The flatness calculator 605 calculates the amplitude flatness in the frequency direction using the amplitudes at the plurality of frequencies. As an example of flatness, a spectrum flatness (SFM: Spectral Flatness Measure) or the like can be used.

The voice section detector 603 receives the SNR and the amplitude flatness, if the SNR is higher than a predetermined threshold, and the flatness is lower than a predetermined threshold, declares that it is a voice section and outputs 1, or outputs 0 otherwise. These values are calculated for each frequency point. The threshold may equally be set at all frequency points or may be set to different values. In a vowel section of a voice, generally, the SNR is high, and the amplitude flatness is low. Hence, the voice section detector 603 can detect a vowel.

The hangover unit 604 holds a detection result in the past during a predetermined number of samples if the output of the voice section detector does not change during the number of samples larger than a predetermined threshold. For example, when a continuous sample count threshold is 4, and the number of held samples is 2, if a non-voice section is determined for the first time after four or more voice sections continued in the past, a value “1” representing a voice section is forcibly output during two samples after that. This can prevent an adverse effect that occurs because the power is generally weak at the termination of a voice section, and the portion is readily erroneously determined as a non-voice section.

The peak detector 606 searches the amplitudes at the plurality of frequencies in the frequency direction from the low-frequency region to the high-frequency region, and identifies a frequency having an amplitude value larger than values at adjacent frequencies on both the high- and low-frequency sides. Comparison with one sample on each of the high- and low-frequency sides may be performed, or a plurality of conditions to compare with a plurality of samples may be imposed. The number of samples to be compared may be changed between the low-frequency side and the high-frequency side. When a human audible sense characteristic is reflected, in general, comparison with a larger number of samples is performed on the high-frequency side than on the low-frequency side.

The fundamental frequency searcher 607 obtains the lowest value in the detected peak frequencies, and sets it to the fundamental frequency. If the amplitude value at the fundamental frequency is not larger than a predetermined value, or if the fundamental frequency does not fall within a predetermined frequency range, the second lowest peak frequency is set to the fundamental frequency.

The overtone verifier 608 verifies whether an amplitude at a frequency corresponding to an integer multiple of the fundamental frequency is much larger than the amplitude at the fundamental frequency. In general, the amplitude at the fundamental frequency or the amplitude in the second overtone is maximum, and the amplitude becomes smaller as the frequency becomes higher. Hence, an overtone is verified in consideration of this characteristic. Normally, the third to fifth overtones are verified. If the existence of an overtone can be confirmed, 1 is output. Otherwise, 0 is output. The existence of an overtone proves the existence of an obvious harmonic structure.

The hangover unit 609 holds a detection result in the past during a predetermined number of samples if the output of the overtone verifier does not change during the number of samples larger than a predetermined threshold. For example, when a continuous sample count threshold is 4, and the number of held samples is 2, if a non-overtone section is determined for the first time after four or more overtone sections continued in the past, a value “1” representing an overtone section is forcibly output during two samples after that. This can prevent an adverse effect that occurs because the power is generally weak at the termination of a voice section, an overtone is hard to detect, and the portion is readily erroneously determined as a non-overtone section.

The hangover units 604 and 609 perform processing for raising the detection accuracy of a voice section and an overtone section at the termination of a voice section. Hence, even if the hangover units 604 and 609 do not exist, the same vowel detection result can be obtained, although the accuracy changes.

By the above-described operation, the vowel detector 402 can detect a vowel.

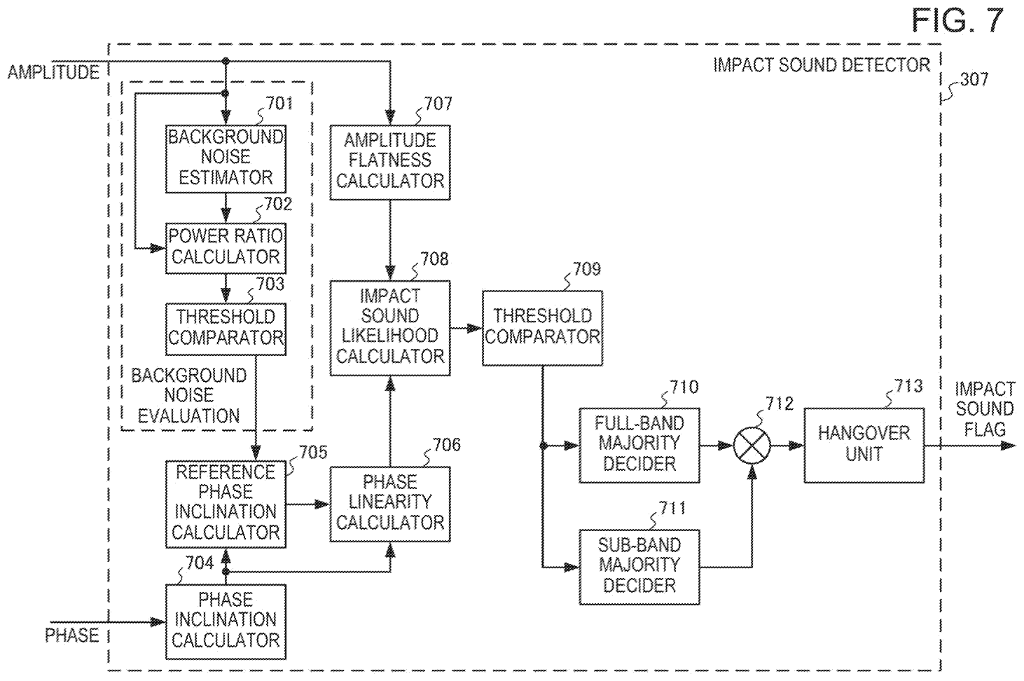

FIG. 7 is a block diagram showing an example of the arrangement of the impact sound detector 307. As shown in FIG. 7, the impact sound detector 307 includes a background noise estimator 701, a power ratio calculator 702, a threshold comparator 703, a phase inclination calculator 704, a reference phase inclination calculator 705, a phase linearity calculator 706, an amplitude flatness calculator 707, an impact sound likelihood calculator 708, a threshold comparator 709, a full-band majority decider 710, a sub-band majority decider 711, an AND calculator 712, and a hangover unit 713.

The background noise estimator 701, the power ratio calculator 702, and the threshold comparator 703 form a background noise evaluator that evaluates whether background noise is sufficiently small as compared to an input signal, and outputs 1 when the background noise is sufficiently small, or 0 otherwise.

The background noise estimator 701 receives the amplitudes at the plurality of frequencies, and estimates background noise on a frequency basis. The operation is basically the same as that of the background noise estimator 601. Hence, when the output of the background noise estimator 601 is used as the output of the background noise estimator 701, the background noise estimator 701 can be omitted.

The power ratio calculator 702 receives the amplitudes at the plurality of frequencies and background noise estimation values at the plurality of frequencies, which are calculated by the background noise estimator 701, and calculates a plurality of power ratios at the frequencies. When the estimated noise is set to the denominator, the power ratio approximately represents the SNR. The operation of the power ratio calculator 702 is the same as that of the power ratio calculator 602. When the output of the power ratio calculator 602 is used as the output of the power ratio calculator 702, the power ratio calculator 702 can be omitted.

The threshold comparator 703 compares each power ratio received from the power ratio calculator 702 with a predetermined threshold, and evaluates whether the background noise is sufficiently small. If the power ratio represents the SNR, the threshold comparator 703 outputs 1 as a background noise evaluation result when the power ratio is sufficiently large, or 0 otherwise. If the reciprocal of the SNR is used as the power ratio, the threshold comparator 703 outputs 1 as a background noise evaluation result when the power ratio is sufficiently small, or 0 otherwise.

The phase inclination calculator 704 receives the phases at the plurality of frequencies, and calculates a phase inclination at each frequency point using the relationship between the phase at a frequency and the phase at an adjacent frequency.

The reference phase inclination calculator 705 receives the background noise evaluation results and the phase inclinations, selects the value of the phase inclination at each frequency point at which the background noise is sufficiently small, and calculates a reference phase inclination based on a plurality of selected phases. For example, the average value of the selected phases may be calculated as the reference phase inclination, or another value such as a median or a mode obtained by statistical processing may be used as the reference phase inclination. That is, the reference phase inclination has the same value for all frequencies.

The phase linearity calculator 706 receives the phase inclinations at the plurality of frequencies and the reference phase inclination, compares them, and obtains a phase linearity as the difference or ratio between them at each frequency point.

The amplitude flatness calculator 707 receives the amplitudes at the plurality of frequencies, and calculates the amplitude flatness in the frequency direction. As an example of flatness, a spectrum flatness (SFM: Spectral Flatness Measure) or the like can be used.

The impact sound likelihood calculator 708 receives the phase linearities and the amplitude flatnesses at the plurality of frequencies, and outputs an impact sound existence probability as an impact sound likelihood. The higher the phase linearity is, the higher the impact sound likelihood is set. In addition, the higher the amplitude flatness is, the higher the impact sound likelihood is set. This is because an impact sound has the characteristics of high phase linearity and high amplitude flatness. The phase linearity and the amplitude flatness can be combined in any way. Only one of them may be used, or a weighted sum of them may be used.

The threshold comparator 709 receives each impact sound likelihood, compares it with a predetermined threshold, and evaluates the existence of an impact sound at each frequency. The threshold comparator 709 outputs 1 when the impact sound likelihood is larger than the predetermined threshold, or 0 otherwise.

The full-band majority decider 710 receives the impact sound existence situations at the plurality of frequencies, and evaluates the existence of an impact sound in the full band (all frequency bands). For example, majority decision concerning 1 representing the existence of an impact sound is made at all frequency points. If the result is majority, it is determined that an impact sound exists at all frequencies, and the values at all frequency points are replaced with 1.

The sub-band majority decider 711 receives the impact sound existence situations at the plurality of frequencies, and evaluates the existence of an impact sound in each sub-band (partial frequency band). For example, majority decision concerning 1 representing the existence of an impact sound is made in each sub-band. If the result is majority, it is determined that an impact sound exists in the sub-band, and the values at all frequency points in the sub-band are replaced with 1.

The AND calculator 712 calculates the AND of impact sound existence information obtained as the result of full-band majority decision and impact sound existence information obtained as the result of sub-band majority decision, and represents final impact sound existence information for each frequency point by 1 or 0.

The hangover unit 713 holds existence information in the past during a predetermined number of samples if the impact sound existence information does not change during the number of samples larger than a predetermined threshold. For example, when a continuous sample count threshold is 4, and the number of held samples is 2, if it is determined that an impact sound is absent for the first time after impact sound existence continued four or more times in the past, a value “1” representing the existence of an impact sound is forcibly output during two samples after that. This can prevent an adverse effect that occurs because the impact sound power is generally weak at the termination of an impact sound section, an impact sound is hard to detect, and it is readily erroneously determined that an impact sound is absent.

The hangover unit 713 performs processing for raising the detection accuracy of an impact sound at the termination of an impact sound section. Hence, even if the hangover unit 713 does not exist, the same impact sound detection result can be obtained, although the accuracy changes. By the above-described operation, the impact sound detector 307 can detect an impact sound.

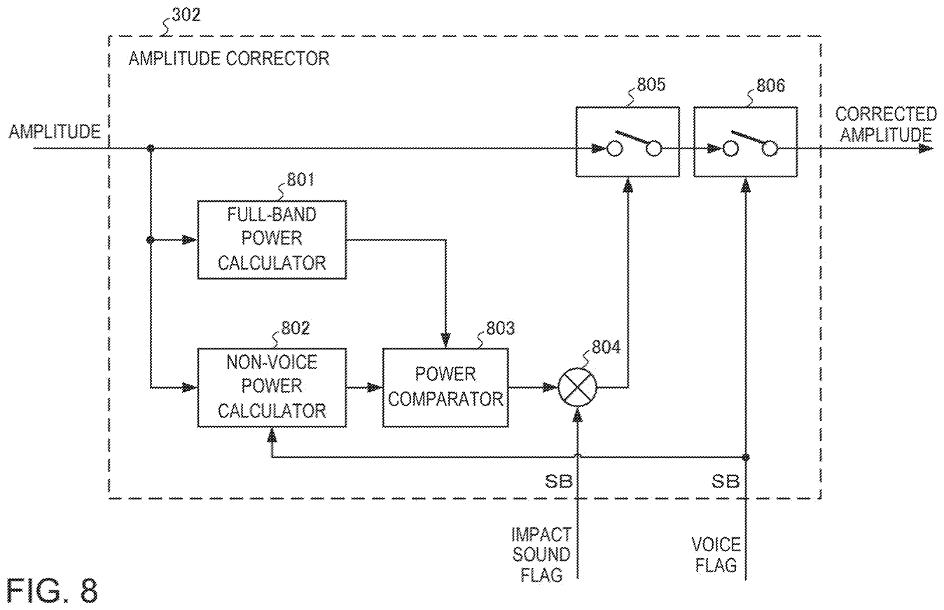

FIG. 8 is a block diagram showing an example of the arrangement of the amplitude corrector 302 shown in FIG. 3. As shown in FIG. 8, the amplitude corrector 302 includes a full-band power calculator 801, a non-voice power calculator 802, a power comparator 803, an AND calculator 804, a switch 805, and a switch 806. The amplitude corrector 302 receives an input signal amplitude, an impact sound flag, and a voice flag, and outputs the input signal amplitude only when the input signal is not an impact sound but a voice.

The full-band power calculator 801 receives the amplitudes at the plurality of frequencies, and obtains the power sum in all bands. The full-band power calculator 801 also divides the power sum by the number of frequency points in all bands, and obtains the quotient as an average full-band power.

The non-voice power calculator 802 receives the amplitudes at the plurality of frequencies and voice flags at the plurality of frequencies, and obtains the power sum of frequency points determined as non-voice. The non-voice power calculator 802 also divides the power sum by the number of frequency points determined as non-voice, and obtains the quotient as an average power of non-voice.

The power comparator 803 receives the average full-band power and the average non-voice power, and obtains the ratio between them. If the value of the ratio is close to 1, the values of the average full-band power and the average non-voice power are close, and the input signal is a non-voice. The power comparator 803 outputs 1 if it is determined that the input signal is a non-voice, or 0 otherwise. That is, 0 represents a voice.

The AND calculator 804 receives the output of the power comparator 803 and the impact sound flag, and outputs the AND of these. That is, the output of the AND calculator 804 is 1 if the input signal is a voice, or 0 otherwise.

The switch 805 receives the output of the AND calculator 804, and when the output of the AND calculator 804 is 0, that is, represents a voice, closes the circuit, and outputs the amplitude of the input signal. The switch 805 further receives the impact sound flag, and if the impact sound flag is 1, that is, an impact sound flag exists, and the input is a voice, may reduce the amplitude at a frequency between the peak frequencies of the voice. This corresponds to reducing the amplitude spectrum between the peak frequencies, and provides an effect of making the amplitude spectrum that is flattened by the impact sound component close to the amplitude spectrum of the voice.

The switch 806 receives the output of the switch 805 and the voice flag, and when the voice flag is 0, that is, a voice exists, closes the circuit, and outputs the output of the switch 805 as a corrected amplitude.

By the above-described operation, the amplitude corrector 302 can output the input signal amplitude as a corrected amplitude only when the input signal is not an impact sound but a voice.

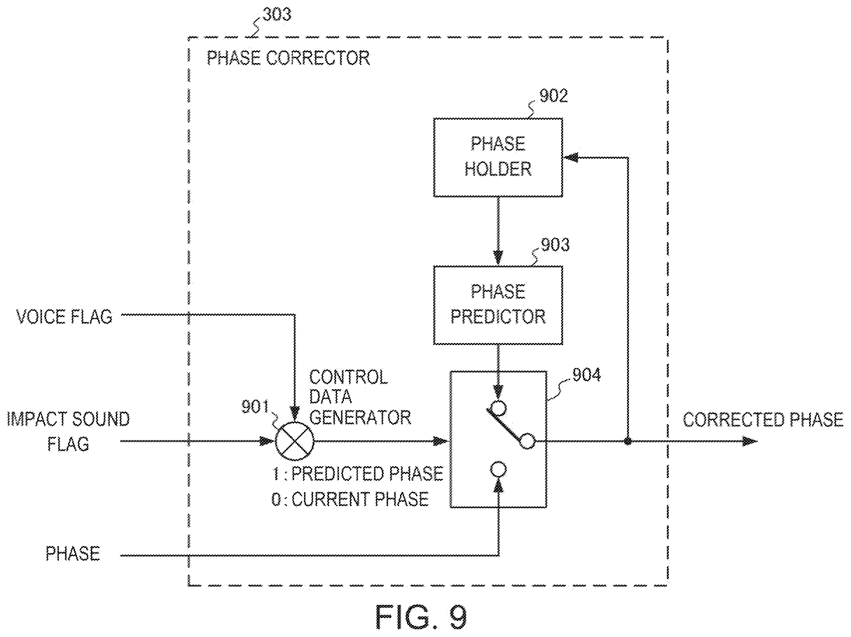

FIG. 9 is a block diagram showing an example of the arrangement of the phase corrector 303. As shown in FIG. 9, the phase corrector 303 includes a control data generator 901, a phase holder 902, a phase predictor 903, and a switch 904. The phase corrector 303 receives the voice flag, the impact sound flag, and the phase of the input signal, and outputs, as a corrected phase, the phase of the input signal when the input signal is a voice, a predicted phase when the input signal is not a voice but an impact sound, and the phase of the input signal when the input signal is neither a voice nor an impact sound.

The control data generator 901 receives the voice flag and the impact sound flag, and outputs control data. The control data generator 901 outputs 1 when the voice flag is 1, 0 when the voice flag is 0, and the impact sound flag is 1, and 1 when both the voice flag and the impact sound flag are 0. If both the voice flag and the impact sound flag are 0, the power of the input signal is not large. Hence, since the influence on the output signal can be neglected, the control data generator 901 may output 0 when both the voice flag and the impact sound flag are 0. In this case, independently of the value of the impact sound flag, the output of the control data generator 901 is 1 when the voice flag is 1 or 0 when the voice flag is 0. That is, the control data generator 901 may be configured to receive only the voice flag and output, as control data, 1 when the voice flag is 1 or 0 when the voice flag is 0.

The phase holder 902 receives the corrected phase that is the output of the phase corrector 303, and holds it. The phase predictor 903 receives the phase held by the phase holder 902, and predicts the current phase using it. Letting f be the frequency, Fs be the sampling frequency, and M be the number of samples of a frame shift, the time shift between adjacent frames is M/Fs sec. The phase advances by 2πf in a second. Hence, letting θk be the phase in a frame k, and θk−1 be the phase in a frame k−1, θk=θk−1+2πfM/Fs holds. That is, the phase held by the phase holder 902 is θk−1, and the predicted phase output from the phase predictor 903 is θk.

The switch 904 selects the phase of the input signal when the control data supplied from the control data generator 901 is 1, or the predicted phase when the control data supplied from the control data generator 901 is 0, and outputs the selected phase as a corrected phase.

By the above-described operation, the phase corrector 303 outputs, as a corrected phase, the phase of the input signal when the input signal is a voice, the predicted phase when the input signal is not a voice but an impact sound, and the phase of the input signal when the input signal is neither a voice nor an impact sound.

With this arrangement, the signal processing apparatus 200 can generate a composite signal in which the acoustic signal supplied from the storage unit 201 is composited with the target signal included in the mixed signal.

### Third Example Embodiment

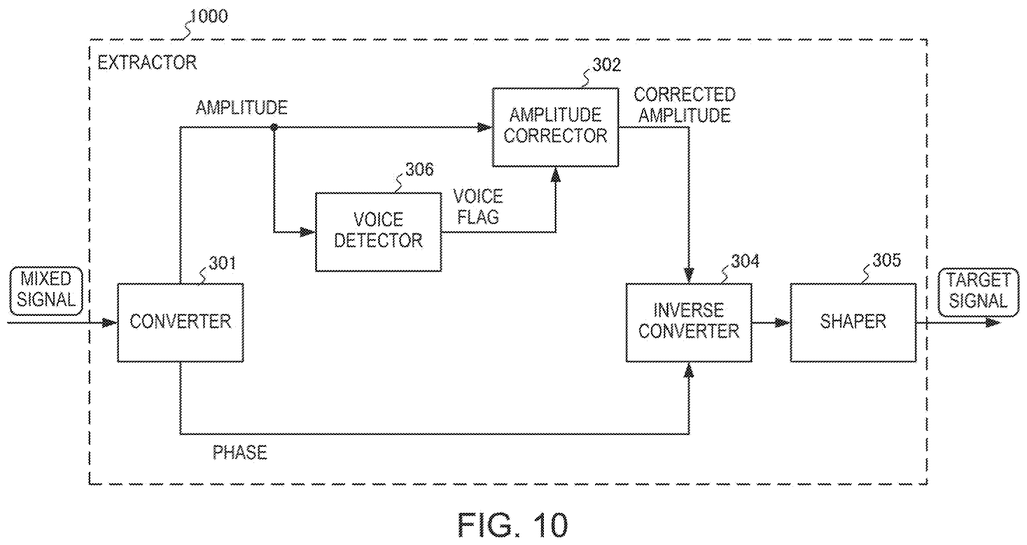

A signal processing apparatus according to the third example embodiment of the present invention will be described next with reference to FIG. 10. The signal processing apparatus according to this example embodiment is different from the second example embodiment in that the signal processing apparatus includes an extractor 1000 having an arrangement simpler than the extractor 221 shown in FIG. 3. The rest of the components and operations is the same as in the second example embodiment. Hence, the same reference numerals denote the same components and operations, and a detailed description thereof will be omitted.

As shown in FIG. 10, the phase corrector 303 and the impact sound detector 307, which exist in the extractor 221 shown in FIG. 3, do not exist in the extractor 1000.

For this reason, the extractor does not detect an impact sound and does not correct a phase upon detecting. If an impact sound is not included in an input signal, phase correction is unnecessary. Hence, if an impact sound is not included in an input, the signal processing apparatus according to the third example embodiment can obtain the same effect by a simple arrangement, as compared to the second example embodiment.

### Fourth Example Embodiment

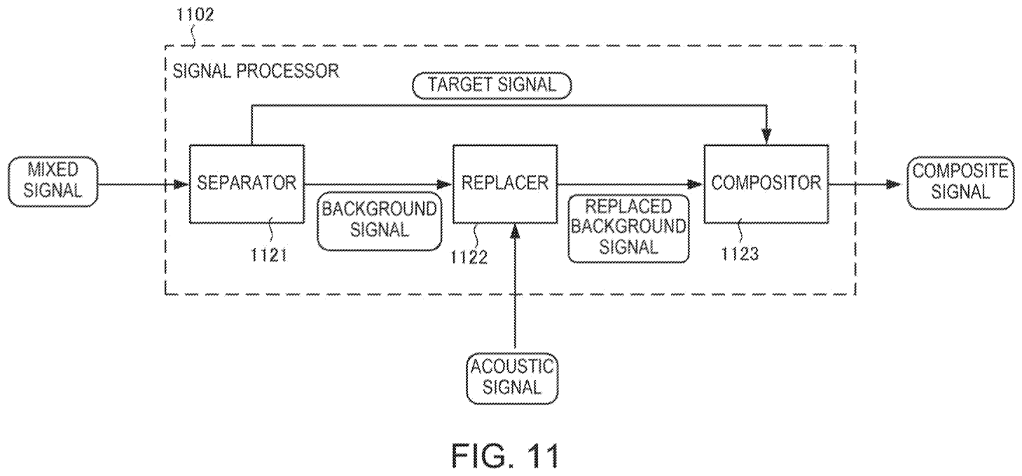

A signal processing apparatus according to the fourth example embodiment of the present invention will be described with reference to FIG. 11. The signal processing apparatus according to this example embodiment has an arrangement in which the signal processor 202 shown in FIG. 2 is replaced with a signal processor 1102 shown in FIG. 11.

As shown in FIG. 11, the signal processor 1102 receives a mixed signal including a target signal and a background signal, replaces the background signal with another acoustic signal, and outputs the signal as a composite signal. A separator 1121 receives the mixed signal including the target signal and the background signal, and separates the target signal and the background signal. A replacer 1122 receives the background signal and the new acoustic signal, and outputs the new acoustic signal as a replaced background signal. A compositor 1123 receives the target signal and the replaced background signal, composites the target signal and the replaced background signal, and outputs the composite signal.

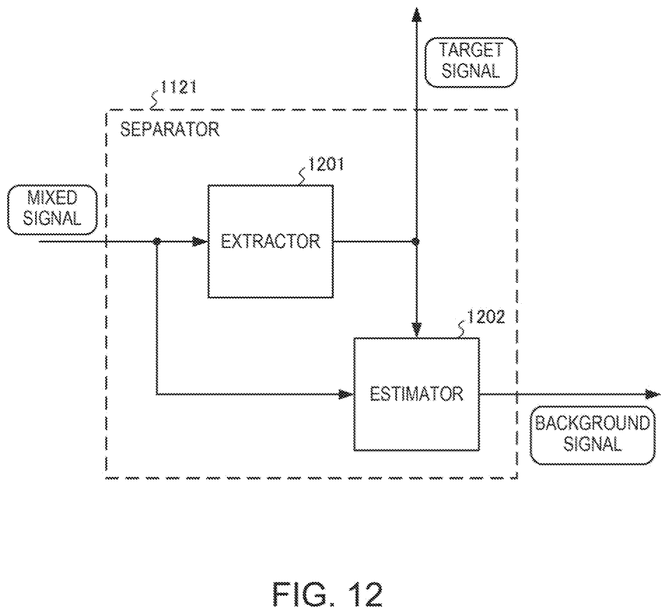

FIG. 12 is a block diagram showing an example of the arrangement of the separator 1121 shown in FIG. 11. As shown in FIG. 12, the separator 1121 has an arrangement including an extractor 1201 and an estimator 1202.

The extractor 1201 receives the mixed signal, and extracts the target signal. The extractor 1201 has a configuration generally called a noise suppressor. Details of the noise suppressor are disclosed in patent literature 2, patent literature 3, non-patent literature 1, non-patent literature 2, and the like. The internal arrangement of the extractor 1201 may be the same as that of the extractor 221 shown in FIG. 3 or the extractor 1000 shown in FIG. 10.

The estimator 1202 estimates the background signal based on the majority decision and the target signal. The mixed signal is the sum of the target signal and the background signal. If it is assumed that the target signal and the background signal have no correlation, the power of the mixed signal is the sum of the power of the target signal and the power of the background signal. Hence, the estimator 1202 obtains the power of the mixed signal and the power of the target signal, and subtracts the latter from the former, thereby obtaining the power of the background signal. The estimator 1202 combines the phase of the mixed signal with the obtained subtraction result, thereby obtaining the background signal. In addition, the estimator 1202 may obtain, as the background signal, the result of simply subtracting the target signal that is the output of the extractor 1201 from the mixed signal. Processing of the estimator 1202 may be performed in the time domain, or may be performed in the frequency domain after the signal is converted into the frequency domain using Fourier transformation or the like. When executing the processing in the frequency domain, after the power and the phase are combined, the signal is converted into a time domain signal.

### Fifth Example Embodiment

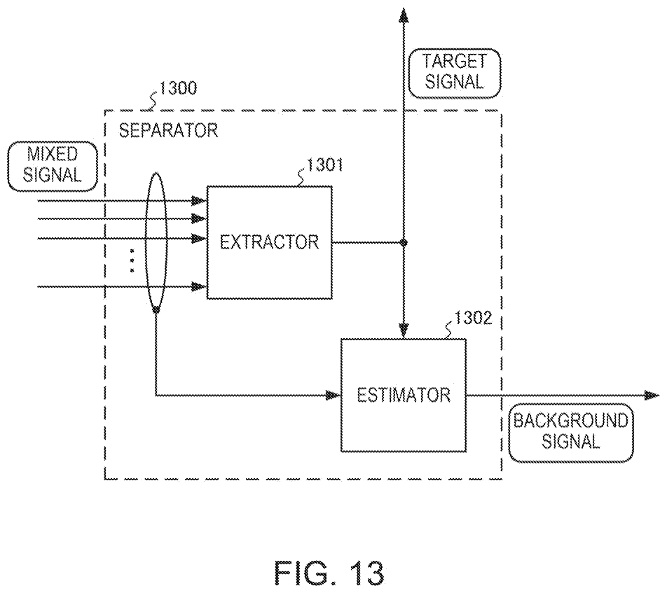

A signal processing apparatus according to the fifth example embodiment of the present invention will be described with reference to FIG. 13. The signal processing apparatus according to this example embodiment has an arrangement in which the separator 1121 shown in FIG. 12 is replaced with a separator 1300 shown in FIG. 13.

As shown in FIG. 13, the separator 1300 includes an extractor 1301 and an estimator 1302. The extractor 1301 receives a plurality of mixed signals, extracts a target signal based on the directivity, and outputs it. The plurality of mixed signals are acquired by a plurality of sensors arranged at equal intervals on a straight line, and have different phases and amplitudes in accordance with the positional relationship between the sensors. Note that the sensors may be arranged not on the straight line but in a circular pattern or an arc pattern. If the sensors have different intervals, acquired signals can be used by performing additional processing of converting the circle or arc into a straight line or correcting the sensor intervals. The extractor 1301 has a configuration generally called a beam former. Details of the beam former are disclosed in patent literature 4, patent literature 5, non-patent literature 3, and the like. As the separator 1300, filtering based on a phase difference shown in non-patent literature 5 may be applied.

The estimator 1302 receives the plurality of mixed signals and the target signal, and obtains a background signal. The estimator 1302 is different from the estimator 1202 in that the estimator 1302 receives a plurality of mixed signals and integrates these into a single mixed signal. The rest of the components and operations is the same as in the estimator 1202. Hence, the same reference numerals denote the same components and operations, and a detailed description thereof will be omitted.

As the single mixed signal, an arbitrary one of the plurality of mixed signals can be selected and used. Alternatively, a statistic value concerning these signals may be used. As the statistic value, an average value, a maximum value, a minimum value, a median, or the like can be used. The average value and the median each give a signal in a virtual sensor that exists at the center of the plurality of sensors. The maximum value gives a signal in a sensor whose distance to the signal is shortest when the signal arrives from a direction other than the front. The minimum value gives a signal in a sensor whose distance to the signal is longest when the signal arrives from a direction other than the front. Simple addition of these signals can also be used. Alternatively, any one of array signal processes shown in non-patent literature 4 may be applied. Array signal processes include a delay sum beam former, a filter sum beam former, an MSNR (Maximum Signal-to-Noise Ratio) beam former, an MMSE (Minimum Mean Square Error) beam former, an LCMV (Linearly Constrained Minimum Variance) beam former, a nested beam former, and the like, and are not limited to these. A thus calculated value is used as a single mixed signal.

The estimator 1302 receives the single mixed signal obtained by the integration and the target signal, and obtains the background signal by the same method as the estimator 1202.

With this arrangement, in addition to the effect of the fourth example embodiment, the separator extracts the target signal using the directivity, and then separates the background signal. It is therefore possible to provide a signal processing apparatus having high performance especially to a mixed signal including a signal that arrives from a specific direction.

### Sixth Example Embodiment

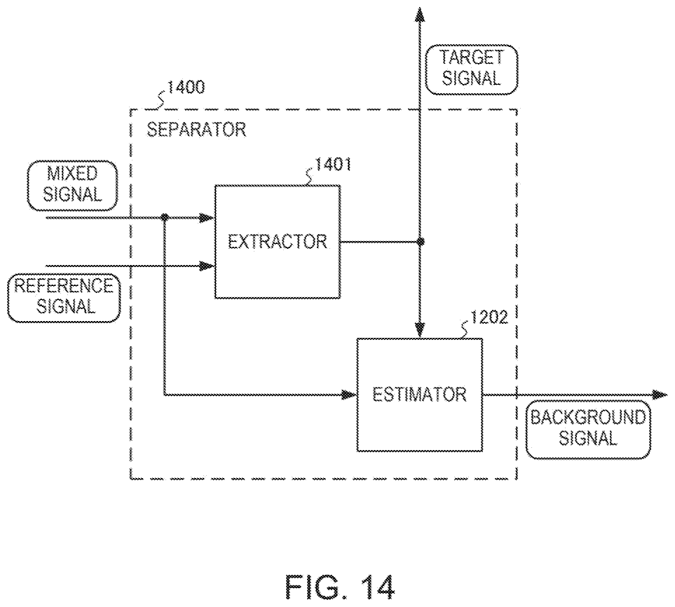

A signal processing apparatus according to the sixth example embodiment of the present invention will be described with reference to FIG. 14. The signal processing apparatus according to this example embodiment has an arrangement in which the separator 1121 shown in FIG. 12 is replaced with a separator 1400 shown in FIG. 14. The separator 1400 is different from the separator 1121 in that the extractor 1201 is replaced with an extractor 1401. The rest of the components and operations is the same as in the separator 1121. Hence, the same reference numerals denote the same components and operations, and a detailed description thereof will be omitted.

The extractor 1401 receives a mixed signal and a reference signal correlated with a background signal, and extracts a target signal. The extractor 1401 has a configuration generally called a noise canceller. Details of the noise canceller are disclosed in patent literature 6, patent literature 7, non-patent literature 6, and the like.

With this arrangement, according to this example embodiment, the background signal is separated after the target signal is extracted using the reference signal. It is therefore possible to provide a signal processing apparatus having high performance especially to a mixed signal including a diffusive signal.

### Seventh Example Embodiment

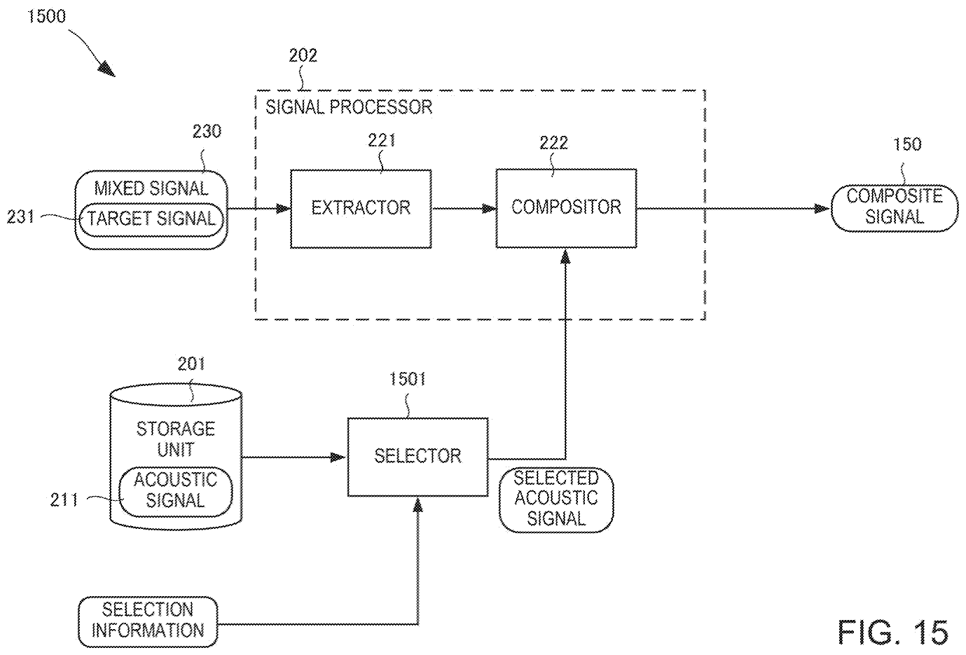

A signal processing apparatus according to the seventh example embodiment of the present invention will be described with reference to FIG. 15. The signal processing apparatus according to this example embodiment is different from the second example embodiment shown in FIG. 2 in that a selector 1501 that inputs selection information is added. The rest of the components and operations is the same as in the second example embodiment. Hence, the same reference numerals denote the same components and operations, and a detailed description thereof will be omitted.

As shown in FIG. 15, the selector 1501 receives acoustic signals from a storage unit 201, and selects a specific acoustic signal of these based on selection information, thereby generating a selected acoustic signal. Which one of the acoustic signals received from the storage unit 201 should be selected is decided based on the selection information. The storage unit 201 stores many acoustic signals 211. Examples are a bird's song, the murmur of a stream, the bustle of a city, and an advertisement voice. The selector 1501 may incorporate an artificial intelligence and select an acoustic signal assumed to be optimum from the storage unit 201 based on the past action history of a user, or the like.

With this arrangement, according to this example embodiment, since an appropriate one of the plurality of acoustic signals stored in the storage unit can be selected in accordance with selection information and replaced with a background signal, it is possible to select a background signal according to the user's intention or the situation of the place and composite it with a target signal.

### Eighth Example Embodiment

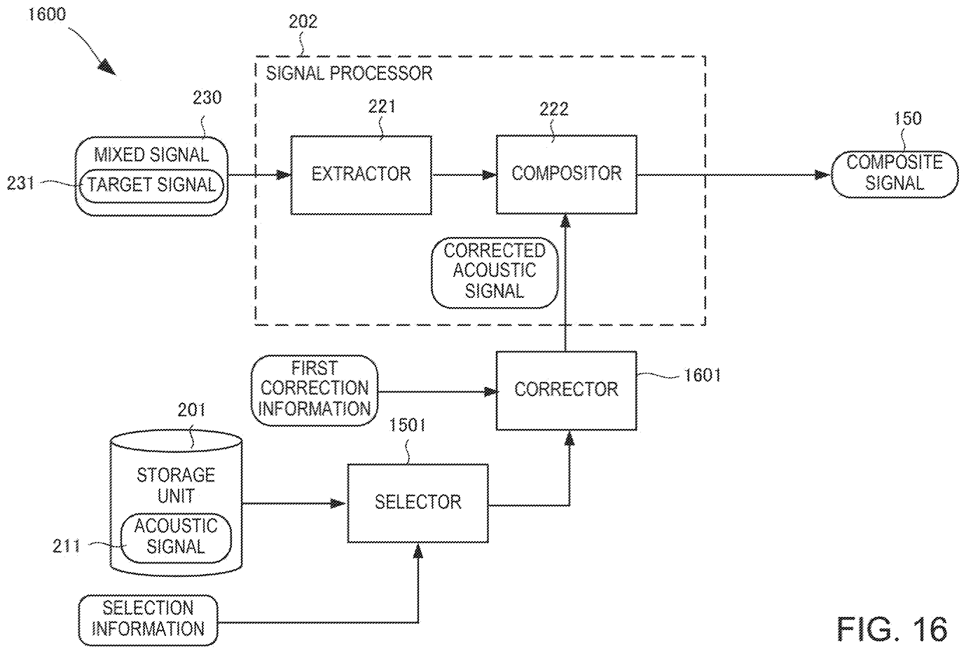

A signal processing apparatus according to the eighth example embodiment of the present invention will be described next with reference to FIG. 16. FIG. 16 is a block diagram for explaining the arrangement of a signal processing apparatus 1600 according to this example embodiment. The signal processing apparatus 1600 according to this example embodiment is different from the seventh example embodiment in that the signal processing apparatus includes a corrector 1601. The rest of the components and operations is the same as in the seventh example embodiment. Hence, the same reference numerals denote the same components and operations, and a detailed description thereof will be omitted.

As shown in FIG. 16, the corrector 1601 receives a selected acoustic signal from a selector 1501, corrects it, and transmits the corrected acoustic signal to a signal processor 202. The degree of correcting the selected acoustic signal is decided based on first correction information. For example, to obtain, by the corrector 1601, the corrected acoustic signal by multiplying the selected acoustic signal by 2.5, 2.5 is supplied as the first correction information. The first correction information may have different values at a plurality of frequencies.

With this arrangement, according to this example embodiment, since the selected acoustic signal can be replaced with the background signal after correction based on the first correction information, it is possible to appropriately set the relationship of the amplitude or power between the target signal and the background signal in the composite signal in accordance with the user's intention or the situation of the place.

### Ninth Example Embodiment

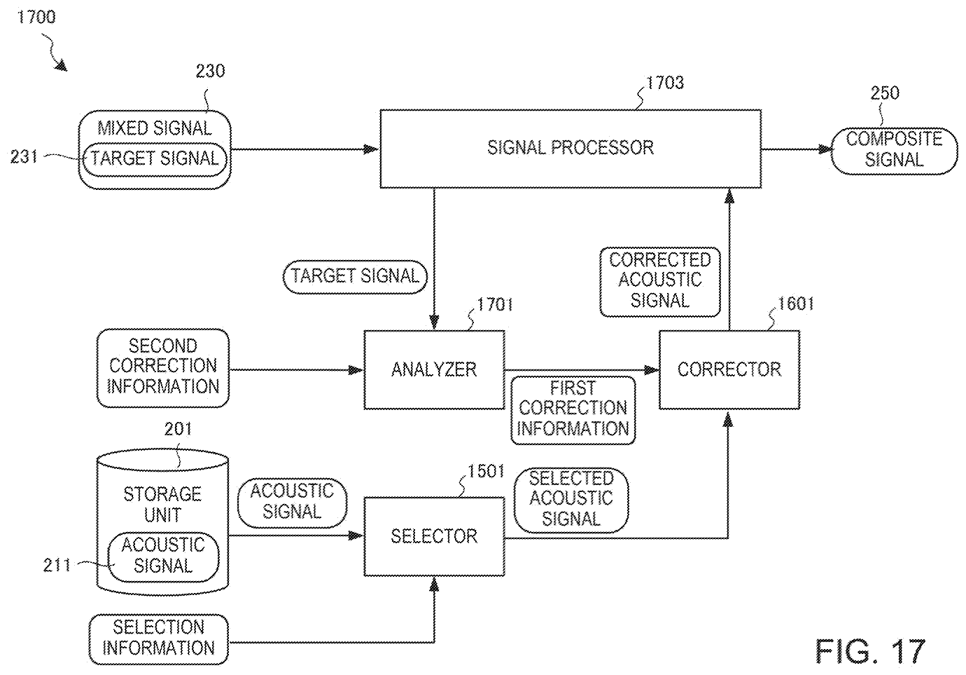

A signal processing apparatus according to the ninth example embodiment of the present invention will be described with reference to FIG. 17. A signal processing apparatus 1700 according to this example embodiment is different from the eighth example embodiment shown in FIG. 16 in that an analyzer 1701 is added, and the signal processor 202 is replaced with a signal processor 1703. The rest of the components and operations is the same as in the eighth example embodiment. Hence, the same reference numerals denote the same components and operations, and a detailed description thereof will be omitted.

As shown in FIG. 17, the signal processor 1703 has the same arrangement and performs the same operation as the signal processor 202 except that a target signal separated from a mixed signal is supplied to the outside.

The analyzer 1701 receives a target signal from the signal processor 1703, and obtains an amplitude or power. The analyzer 1701 also receives second correction information, and obtains first correction information from the amplitude or power of the target signal and the second correction information.

In the eighth example embodiment shown in FIG. 16, the degree of correcting the selected acoustic signal is defined by the first correction information given from the outside. In this example embodiment, the first correction information is calculated using the second correction information given from the outside and the amplitude or power obtained by analyzing the target signal by the analyzer 1701. The second correction information is, for example, the ratio (target signal to background signal ratio) of the target signal to a replaced background signal in a composite signal. If the target signal to background signal ratio and the amplitude or power of the target signal are known, the amplitude or power that the background signal should have can easily be obtained. Since the amplitude or power of each acoustic signal stored in a storage unit 201 is known, the first correction information can be calculated from the amplitude or power that the background signal should have and the amplitude or power of the acoustic signal.

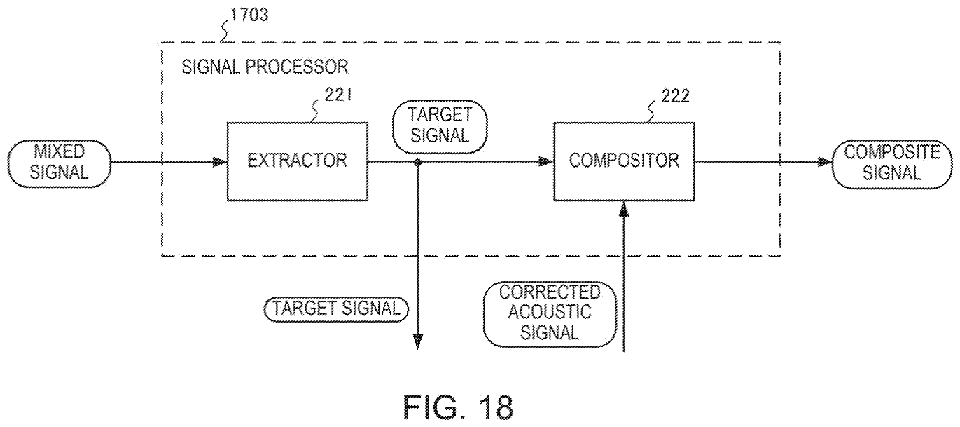

FIG. 18 is a block diagram showing an example of the arrangement of the signal processor 1703. The signal processor 1703 has the same arrangement and performs the same operation as the signal processor 202 shown in FIG. 2 except that a target signal separated from a mixed signal is supplied to the outside. The rest of the components and operations is the same as in the seventh example embodiment. Hence, the same reference numerals denote the same components and operations, and a detailed description thereof will be omitted.

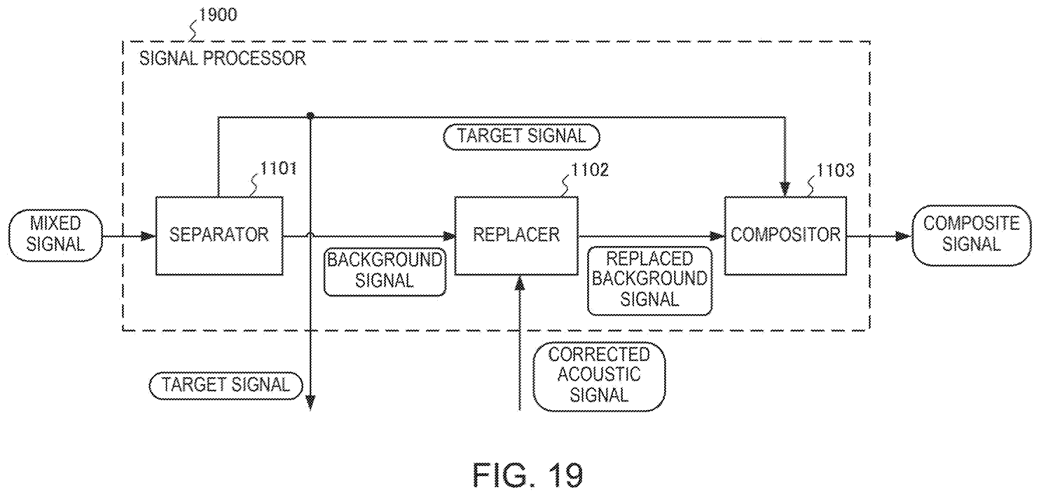

FIG. 19 is a block diagram showing another example of the arrangement of the signal processor 1703. A signal processor 1900 has the same arrangement and performs the same operation as the signal processor 1102 shown in FIG. 11 except that a target signal separated from a mixed signal is supplied to the outside. The rest of the components and operations is the same as in the eighth example embodiment. Hence, the same reference numerals denote the same components and operations, and a detailed description thereof will be omitted.

With this arrangement, according to this example embodiment, it is possible to obtain the first correction information using the second correction information given from the outside and the amplitude or power obtained by analyzing the target signal and replace the selected acoustic signal with the background signal after correction based on the first correction information. As a result, it is possible to appropriately set the relationship of the amplitude or power between the target signal and the background signal in the composite signal in accordance with the user's intention or the situation of the place.

### 10th Example Embodiment

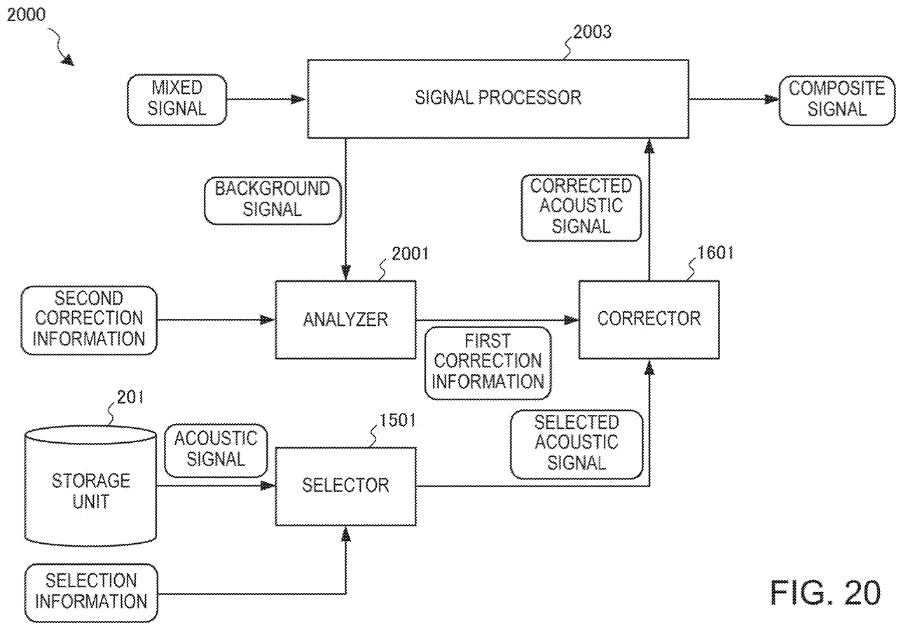

A signal processing apparatus according to the 10th example embodiment of the present invention will be described with reference to FIG. 20. A signal processing apparatus 2000 according to this example embodiment is different from the ninth example embodiment shown in FIG. 17 in that the analyzer 1701 is replaced with an analyzer 2001, and the signal processor 1703 is replaced with a signal processor 2003. The rest of the components and operations is the same as in the ninth example embodiment. Hence, the same reference numerals denote the same components and operations, and a detailed description thereof will be omitted.

The analyzer 2001 receives a separated background signal from the signal processor 2003, and obtains the amplitude or power thereof. Since the amplitude or power of each acoustic signal stored in a storage unit 201 is known, first correction information can be calculated from the amplitude or power that the background signal should have and the amplitude or power of the acoustic signal. The first correction information can be calculated such that the amplitude or power of a corrected acoustic signal equals the amplitude or power of the background signal, or can intentionally be calculated such than one becomes a constant multiple of the other.

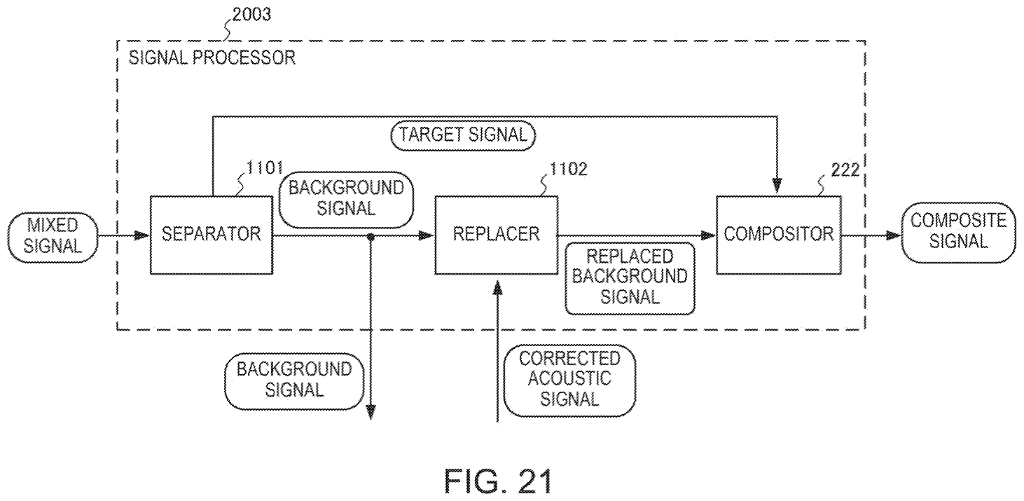

FIG. 21 is a block diagram showing an example of the arrangement of the signal processor 2003. The signal processor 2003 has the same arrangement and performs the same operation as the signal processor 1102 except that the background separated from a mixed signal is supplied to the outside. The rest of the components and operations is the same as in the eighth example embodiment. Hence, the same reference numerals denote the same components and operations, and a detailed description thereof will be omitted.

### 11th Example Embodiment

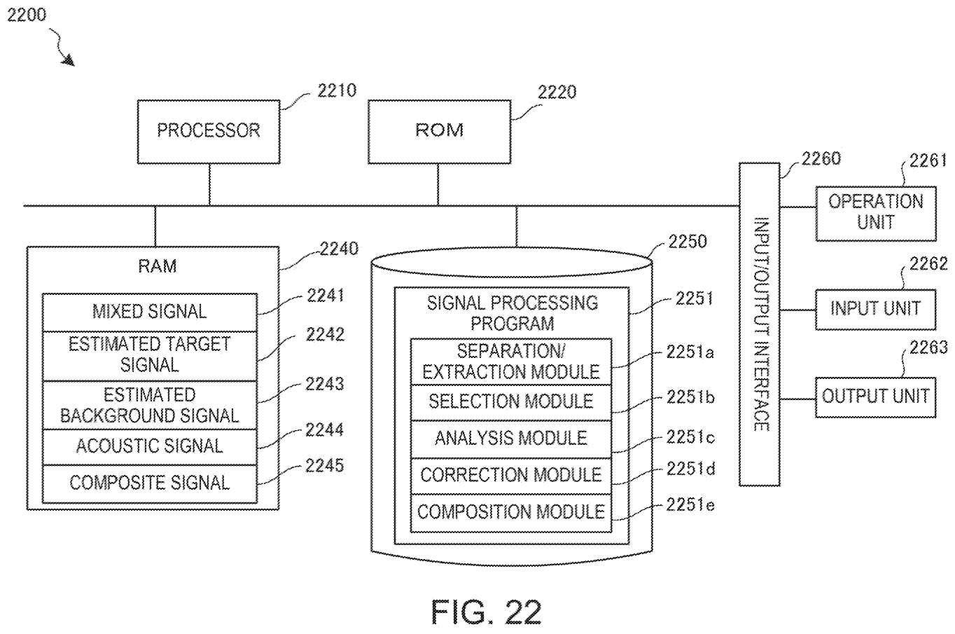

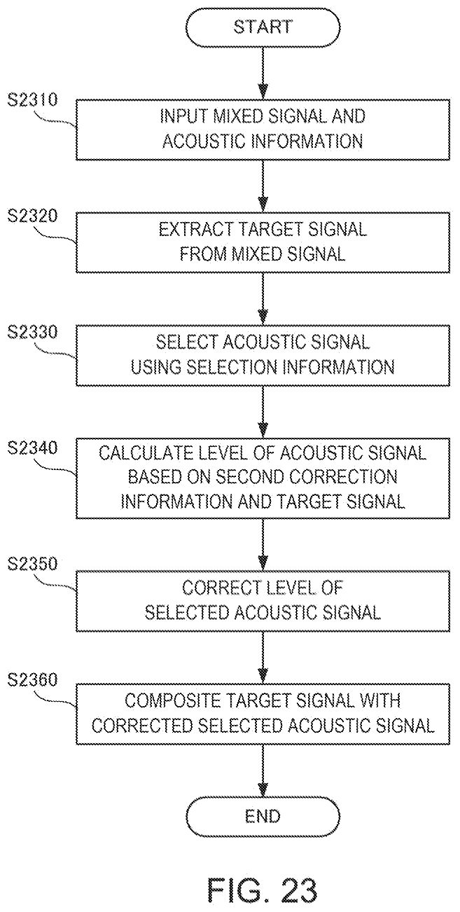

A signal processing apparatus according to the 11th example embodiment of the present invention will be described with reference to FIGS. 22 and 23. FIG. 22 is a block diagram for explaining a hardware arrangement in a case in which a signal processing apparatus 2200 according to this example embodiment is implemented using software.

The signal processing apparatus 2200 includes a processor 2210, a ROM (Read Only Memory) 2220, a RAM (Random Access Memory) 2240, a storage 2250, an input/output interface 2260, an operation unit 2261, an input unit 2262, and an output unit 2263. The processor 2210 is a central processing unit, and controls the entire signal processing apparatus 2200 by executing various programs.

The ROM 2220 stores various kinds of parameters and the like in addition to a boot program that the processor 2210 should execute first. In addition to a program load area (not shown), the RAM 2240 includes areas configured to store a mixed signal 2241 (input signal), a target signal (estimation value) 2242 a background signal (estimation value) 2243, an acoustic signal 2244, a composite signal 2245 (output signal), and the like.

The storage 2250 stores a signal processing program 2251. The signal processing program 2251 includes a separation/extraction module 2251a, a selection module 2251b, an analysis module 2251c, a correction module 2251d, and a composition module 2251e. The processor 2210 executes the modules included in the signal processing program 2251, thereby implementing the functions included in the above-described example embodiments, such as the signal processor 102 shown in FIG. 1 and the extractor 221 and the compositor 222 shown in FIG. 2.

The composite signal 2245 that is an output concerning the signal processing program 2251 executed by the processor 2210 is output from the output unit 2263 via the input/output interface 2260. This makes it possible to replace, for example, a background signal other than a target signal included in the mixed signal 2241 input from the input unit 2262 with another acoustic signal.

FIG. 23 is a flowchart for explaining an example of processing executed by the signal processing program 2251. The series of processes implements the same function as the signal processing apparatus 1700 described with reference to FIG. 17. In step S2310, the mixed signal 2241 including a target signal and a background signal is supplied to the separation/extraction module 2251a. In step S2320, the separation/extraction module 2251a extracts the target signal.

Next, in step S2330, the selection module 2251b is executed, thereby selecting an acoustic signal using selection information. Next, in step S2340, the analysis module 2251c is executed, thereby calculating first correction information (the level of the acoustic signal) from second correction information and the target signal. In step S2350, the correction module 2251d is executed, thereby correcting the selected acoustic signal by the first correction information. In step S2360, the composition module 2251e is executed, thereby compositing the target signal with the corrected selected acoustic signal. In these processes, the processing order of steps S2320 and S2330 and steps S2330 and S2340 can be reversed.

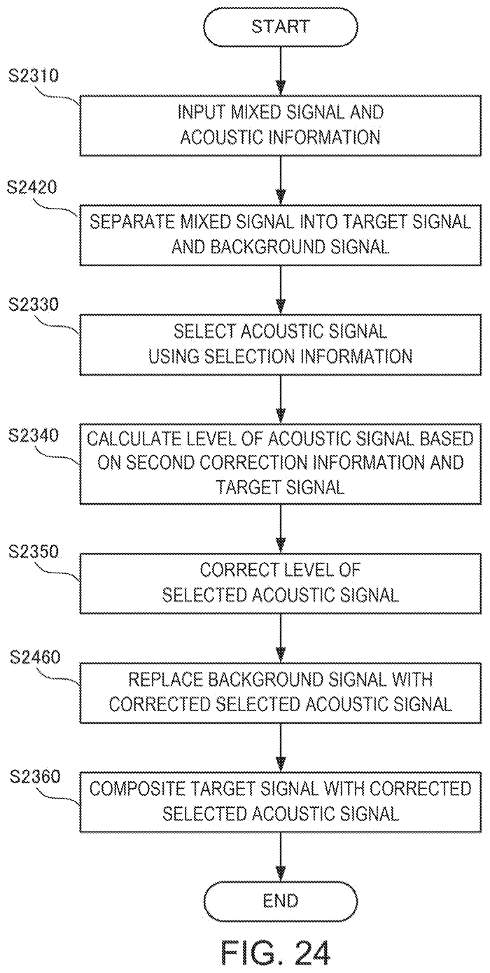

FIG. 24 is a flowchart for explaining the procedure of another processing by the signal processing program 2251. This processing is different from the processing described with reference to FIG. 23 in that the target signal and the background signal are separated in step S2420, and the background signal is replaced with the corrected selected acoustic signal in step S2460. The rest of the processing is the same as in FIG. 23. Hence, the same step numbers denote the same processes, and a description thereof will be omitted.

An example of the procedure of processing in a case in which the above-described arrangements including the signal processor 1703 and the signal processor 1900 are implemented by software in the signal processing apparatus according to this example embodiment has been described with reference to FIGS. 23 and 24. However, any of the first to ninth example embodiments can similarly be implemented by software by appropriately omitting and adding the differences in the block diagrams.

With this arrangement, the signal processing apparatus can generate a composite signal in which a target signal and an acoustic signal different from an original background signal are mixed.

### 12th Example Embodiment

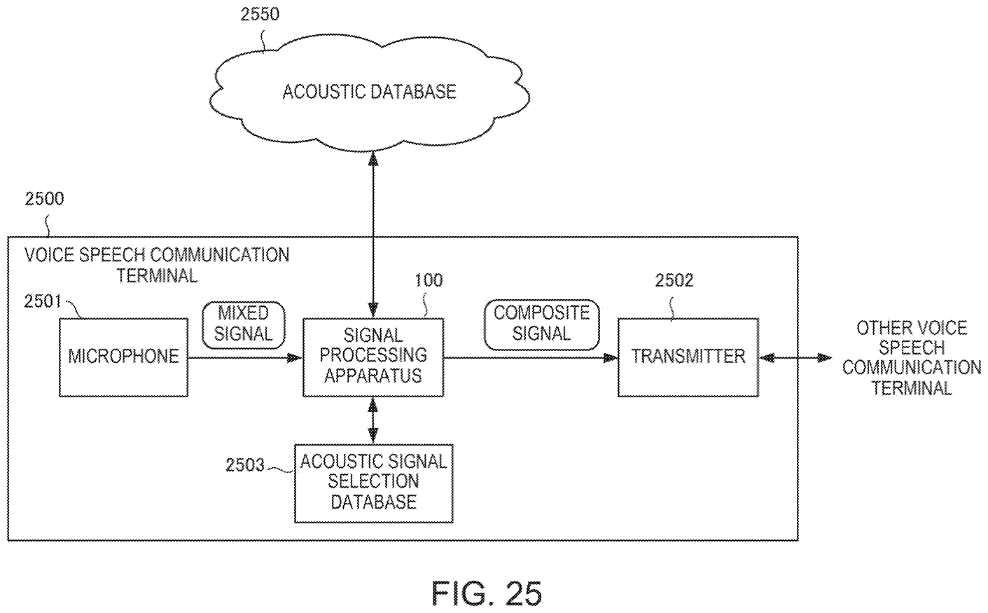

A voice speech communication terminal according to the 12th example embodiment of the present invention will be described next with reference to FIG. 25. FIG. 25 is a block diagram for explaining the arrangement of a voice speech communication terminal 2500 according to this example embodiment. The voice speech communication terminal 2500 according to this example embodiment includes one of the signal processing apparatuses described in the first to 11th example embodiments, in addition to a microphone 2501 and a transmitter 2502. A description will be made here assuming that the voice speech communication terminal includes a signal processing apparatus 100.

The microphone 2501 inputs a mixed signal. The signal processing apparatus 100 composites a user voice signal as a target signal included in the input mixed signal with an acoustic signal prepared in advance. The transmitter 2502 transmits the composited composite signal to another voice speech communication terminal.

The voice speech communication terminal 2500 may download acoustic data from an acoustic database 2550 on the Internet. At this time, the user may be charged.

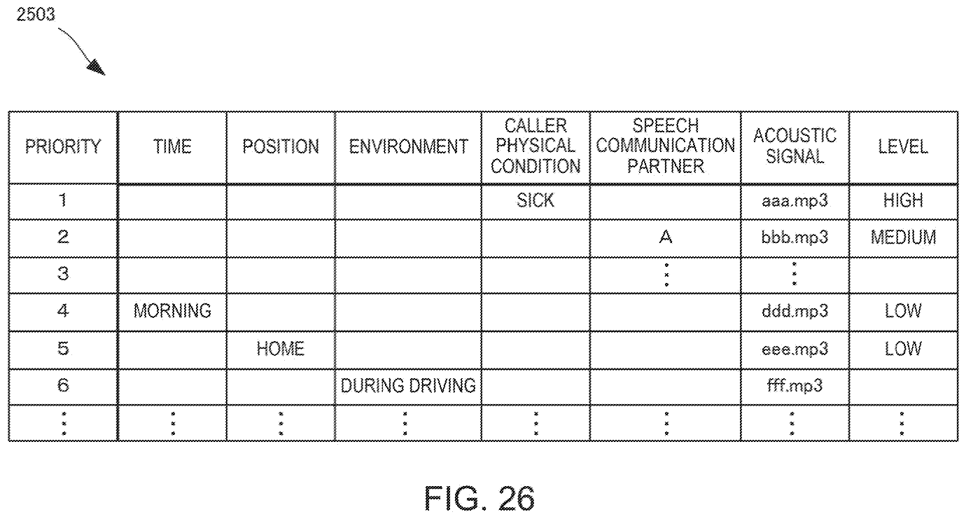

Also, the voice speech communication terminal 2500 may include an acoustic signal selection database 2503 configured to set a condition to select an acoustic signal. An example of the acoustic signal selection database 2503 is shown in FIG. 26.

Basically, the acoustic signal selection database 2503 can set an acoustic signal in correspondence with each speech communication partner.

However, an acoustic signal corresponding to a group of speech communication partners, for example, an acoustic signal to be added in speech communication with a family, an acoustic signal to be added in speech communication with a friend, or an acoustic signal to be added in speech communication with an office may be set.

An acoustic signal to be composited may be selected in accordance with various speech communication situations. For example, if the user does not feel well, an emergency acoustic signal (here, aaa.mp3) “◯◯ cannot speak because of poor physical conditions. Please send a message by email” may be composited and transmitted independently of the speech communication partner. In this case, the physical conditions of the user may automatically be managed by synchronizing the voice speech communication terminal 2500 with a wearable terminal (not shown).

In addition, settings can done such that, for example, a specific acoustic signal is added to speech communication during the morning, a specific acoustic signal is added to speech communication from the home, a specific acoustic signal is added to speech communication during driving of a vehicle or during traveling of a bicycle.

As described above, according to this example embodiment, it is possible to freely change the background sound during speech communication and make a speech communication partner listen to it.

### 13th Example Embodiment

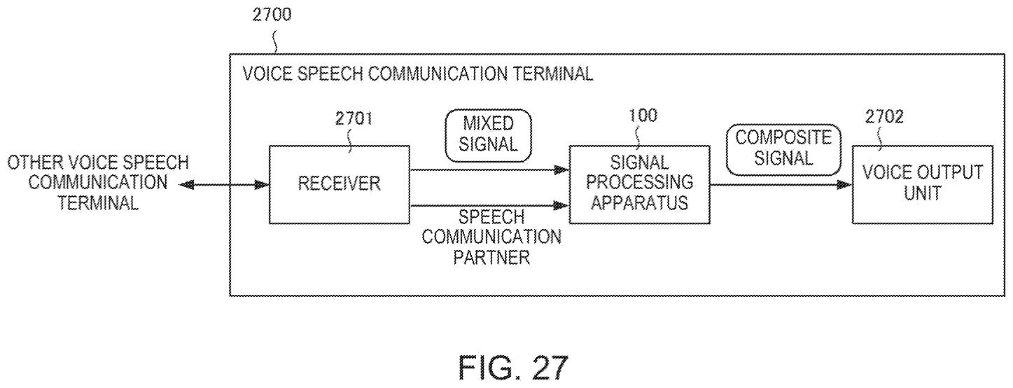

A voice speech communication terminal according to the 13th example embodiment of the present invention will be described next with reference to FIG. 27. FIG. 27 is a block diagram for explaining the arrangement of a voice speech communication terminal 2700 according to this example embodiment. The voice speech communication terminal 2700 according to this example embodiment includes one of the signal processing apparatuses described in the first to 11th example embodiments, in addition to a receiver 2701 and a voice output unit 2702. A description will be made here assuming that the voice speech communication terminal includes a signal processing apparatus 100.

The receiver 2701 receives a mixed signal and information representing a speech communication partner from another voice speech communication terminal. The signal processing apparatus 100 composites a user voice signal as a target signal included in the received mixed signal with an acoustic signal prepared in advance. The voice output unit 2702 outputs the composited composite signal as a voice.

The acoustic signal to be used in composition can be selected in accordance with a time, a position, an environment, and the physical condition of the receiver, as in the 12th example embodiment. It is also possible to appropriately set the signal level at the time of composition. Data corresponding to a table shown in FIG. 26 is prepared for the purpose.

According to this example embodiment it is possible to enjoy a speech communication while listening to a favorite background sound in accordance with the speech communication partner, as in the 12th example embodiment.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims. A system or apparatus including any combination of the individual features included in the respective example embodiments may be incorporated in the scope of the present invention.

The present invention is applicable to a system including a plurality of devices or a single apparatus. The present invention is also applicable even when an information processing program for implementing the functions of example embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described example embodiments.

### Other Expressions of Example Embodiments

Some or all of the above-described embodiments can also be described as in the following supplementary notes but are not limited to the followings.

(Supplementary Note 1)

There is provided a signal processing apparatus comprising:

a storage unit that stores an acoustic signal; and

a signal processor that receives a mixed signal including at least one target signal, and composites the acoustic signal stored in the storage unit with the target signal.

(Supplementary Note 2)

There is provided the signal processing apparatus according to Supplementary Note 1, wherein the storage unit stores a plurality of types of acoustic signals, and

the signal processing apparatus further comprises a selector that selects, from the storage unit, the acoustic signal to be composited with the target signal.

(Supplementary Note 3)

There is provided the signal processing apparatus according to Supplementary Note 1 or 2, further comprising a corrector that corrects a level of the acoustic signal read out from the storage unit before composition with the target signal.

(Supplementary Note 4)

There is provided the signal processing apparatus according to Supplementary Note 3, wherein the corrector corrects the level of the acoustic signal read out from the storage unit in accordance with a level of the target signal included in the mixed signal.

(Supplementary Note 5)

There is provided the signal processing apparatus according to Supplementary Note 3, wherein the signal processor includes a separator that separates the mixed signal into the target signal and a background signal other than the target signal, and

the corrector corrects the level of the acoustic signal read out from the storage unit in accordance with a level of the background signal included in the mixed signal.

(Supplementary Note 6)

There is provided the signal processing apparatus according to Supplementary Note 4 or 5, wherein the corrector corrects the level of the acoustic signal based on a ratio of the target signal and the acoustic signal, which is externally designated.

(Supplementary Note 7)

There is provided a voice speech communication terminal incorporating a signal processing apparatus described in any one of Supplementary Notes 1 to 6, comprising

a microphone that inputs a mixed signal,

wherein a signal processor composites a user voice signal as a target signal included in the input mixed signal with an acoustic signal prepared in advance, and

the voice speech communication terminal further comprises a transmitter that transmits a composited composite signal.

(Supplementary Note 8)

There is provided the voice speech communication terminal according to Supplementary Note 7, wherein the signal processor selects the acoustic signal to be composited in accordance with one of a speech communication partner and a speech communication situation.

(Supplementary Note 9)

There is provided a voice speech communication terminal incorporating a signal processing apparatus described in any one of Supplementary Notes 1 to 6, comprising

a receiver that receives a mixed signal from a calling-side voice speech communication terminal,

wherein a signal processor composites a user voice signal as a target signal included in the received mixed signal with an acoustic signal prepared in advance, and

the voice speech communication terminal further comprises a voice output unit that outputs a composited composite signal as a voice.

(Supplementary Note 10)

There is provided a signal processing method comprising:

receiving a mixed signal including at least one target signal; and

compositing an acoustic signal stored in advance with the target signal.

(Supplementary Note 11)

There is provided a signal processing program for causing a computer to execute a method, comprising:

receiving a mixed signal including at least one target signal; and

compositing an acoustic signal stored in advance with the target signal.

What is claimed is:

1. A signal processing apparatus comprising:
a storage unit that stores an acoustic signal; and
a signal processor that receives a mixed signal including at least one target signal, and composites the acoustic signal stored in the storage unit with the target signal.

2. The signal processing apparatus according to claim 1, wherein said storage unit stores a plurality of types of acoustic signals, and
the signal processing apparatus further comprises a selector that selects, from the storage unit, the acoustic signal to be composited with the target signal.

3. The signal processing apparatus according to claim 1, further comprising a corrector that corrects a level of the acoustic signal read out from said storage unit before composition with the target signal.

4. The signal processing apparatus according to claim 3, wherein said corrector corrects the level of the acoustic signal read out from said storage unit in accordance with a level of the target signal included in the mixed signal.

5. The signal processing apparatus according to claim 3, wherein said signal processor includes a separator that separates the mixed signal into the target signal and a background signal other than the target signal, and
said corrector corrects the level of the acoustic signal read out from said storage unit in accordance with a level of the background signal included in the mixed signal.

6. The signal processing apparatus according to claim 4, wherein said corrector corrects the level of the acoustic signal based on a ratio of the target signal and the acoustic signal, which is externally designated.

7. A voice speech communication terminal incorporating a signal processing apparatus described in claim 1, comprising
a microphone that inputs a mixed signal,
wherein a signal processor composites a user voice signal as a target signal included in the input mixed signal with an acoustic signal prepared in advance, and
the voice speech communication terminal further comprises a transmitter that transmits a composited composite signal.

8. The voice speech communication terminal according to claim 7, wherein the signal processor selects the acoustic signal to be composited in accordance with one of a speech communication partner and a speech communication situation.

9. A voice speech communication terminal incorporating a signal processing apparatus described in claim 1, comprising
a receiver that receives a mixed signal from a calling-side voice speech communication terminal,
wherein a signal processor composites a user voice signal as a target signal included in the received mixed signal with an acoustic signal prepared in advance, and
the voice speech communication terminal further comprises a voice output unit that outputs a composited composite signal as a voice.

10. A signal processing method comprising:
receiving a mixed signal including at least one target signal; and
compositing an acoustic signal stored in advance with the target signal.

11. A non-transitory computer readable medium storing a signal processing program for causing a computer to execute a method, comprising:
receiving a mixed signal including at least one target signal; and
compositing an acoustic signal stored in advance with the target signal.
